(19) United States
(12) Patent Application Publication
(10) Pub. No.: US 2024/0420002 A1
(43) Pub. Date: Dec. 19, 2024

(54) IMPLEMENTING NET COHERENT ROTATIONS DURING DYNAMICAL DECOUPLING

(71) Applicant: Google LLC, Mountain View, CA (US)

(72) Inventors: Kevin Satzinger, Goleta, CA (US); Alexandre Bourassa, Santa Barbara, CA (US); Dripto Mazumdar Debroy, Los Angeles, CA (US); Kenneth William Lee, Santa Barbara, CA (US); Matthew Neeley, Goleta, CA (US)

(21) Appl. No.: 18/336,656

(22) Filed: Jun. 16, 2023

(51) Int. Cl. G06N 10/40

(52) U.S. Cl. CPC G06N 10/40

(57) ABSTRACT

Methods, systems and apparatus for dynamically decoupling and performing a target unitary operation to a qubit. In one aspect, a method includes generating a control signal that implements a dynamical decoupling control sequence and applying the control signal to the qubit to dynamically decouple the qubit and perform the target unitary operation on the qubit. The target unitary operation includes a product of multiple sub-unitary operations. The dynamical decoupling control sequence includes a plurality of single qubit gates, where one or more of the single qubit gates comprise a single qubit gate that implements one or more of sub-unitary operations of the multiple sub-unitary operations.

### BACKGROUND

This specification relates to quantum computing.

Dynamical decoupling is a quantum control technique used in quantum computing to suppress decoherence. Maintaining quantum coherence is an important requirement for exploiting the possibilities opened up by quantum computation. Practical implementations of quantum computation and communication proposals require methods to effectively resist the action of quantum decoherence and dissipation.

In its simplest form, dynamical decoupling is implemented by periodic sequences of rapid, time-dependent control pulses, whose net effect is to approximately average the unwanted system-environment coupling to zero. Different schemes exist for designing dynamical decoupling protocols that use realistic bounded-strength control pulses, as well as for achieving high-order error suppression, and for making dynamical decoupling compatible with quantum gates. In spin systems in particular, commonly used protocols for dynamical decoupling include the Carr-Purcell and the Carr-Purcell-Meiboom-Gill schemes. These protocols are based on the Hahn spin echo technique of applying periodic pulses to enable refocusing and hence extend the coherence times of qubits.

### SUMMARY

This specification describes technologies for implementing net coherent rotations during dynamical decoupling.

In general, one innovative aspect of the subject matter described in this specification can be implemented in a method for generating a control sequence for implementing a unitary operation and dynamically decoupling a qubit. The method includes obtaining data specifying a target unitary operation and data specifying a dynamical decoupling control sequence; modifying single qubit gates included in the dynamical decoupling control sequence to generate an adjusted dynamical decoupling control sequence that, when applied to a qubit, dynamically decouples the qubit and implements the target unitary operation, wherein modifying the single qubit gates comprises: factoring the target unitary operation as a product of multiple sub-unitary operations; interleaving, using commutation relations of the sub-unitary operations and the single qubit gates included in the dynamical decoupling control sequence, one or more of the sub-unitary operations through the dynamical decoupling control sequence; and adjusting one or more single qubit gates included in the dynamical decoupling control sequence to include the interleaved sub-unitary operations; and providing the adjusted dynamical decoupling control sequence for application to one or more qubits in a quantum computer.

In general, another innovative aspect of the subject matter described in this specification can be implemented in a method for dynamically decoupling and performing a target unitary operation to a qubit. The method includes generating a control signal that implements a dynamical decoupling control sequence; and applying the control signal to the qubit to dynamically decouple the qubit and perform the target unitary operation on the qubit, wherein: the target unitary operation comprises a product of multiple sub-unitary operations; and the dynamical decoupling control sequence comprises a plurality of single qubit gates, wherein one or more of the single qubit gates comprise a single qubit gate that implements one or more of sub-unitary operations of the multiple sub-unitary operations.

Other implementations of these aspects include corresponding computer systems, apparatus, and computer programs recorded on one or more computer storage devices, each configured to perform the actions of the methods. A system of one or more classical and/or quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations interleaving one or more of the sub-unitary operations through the dynamical decoupling control sequence comprises evenly distributing the one or more sub-unitary operations throughout the dynamical decoupling control sequence.

In some implementations the dynamical decoupling control sequence comprises a first number n of single qubit gates and the multiple sub-unitary operations comprises n unitary operations.

In some implementations the target unitary operation comprises a target phase gate that implements a single qubit rotation a and each sub-unitary operation of the multiple sub-unitary operations implements a single qubit rotation a/n.

In some implementations adjusting one or more single qubit gates included in the dynamical decoupling control sequence to include the interleaved sub-unitary operations comprises adjusting phases of the one or more single qubit gates to include respective phases of the interleaved sub-unitary operations.

In some implementations the single qubit rotation comprises a single qubit rotation about the Z axis.

In some implementations adjusting one or more single qubit gates included in the dynamical decoupling control sequence to include the interleaved sub-unitary operations comprises adjusting a proper subset of the single qubit gates included in the dynamical decoupling control sequence to include the interleaved sub-unitary operations.

In some implementations the proper subset comprises single qubit gates of a same type.

In some implementations the target unitary operation comprises a coherent single qubit gate.

In some implementations application of the dynamical decoupling control sequence to a qubit is equivalent to an application of an identity operation to the qubit.

In some implementations the dynamical decoupling control sequence comprises X gates and Y gates.

In some implementations the dynamical decoupling control sequence comprises an n Pi pulse dynamical decoupling scheme, a 2n Pi pulse dynamical decoupling scheme, or a 2n+1 Pi pulse dynamical decoupling scheme.

In some implementations providing the adjusted dynamical decoupling control sequence for application to one or more qubits in a quantum computer comprises, during execution of a quantum computation by the quantum computer: determining that one or more qubits require dynamical decoupling and application of the target unitary operation; and in response to determining that the one or more qubits require dynamical decoupling and application of the target unitary operation, generating a control signal to apply the adjusted dynamical decoupling control sequence to the one or more qubits.

In some implementations the method further comprises applying the generated control signal to the one or more qubits.

In some implementations providing the adjusted dynamical decoupling control sequence for application to one or more qubits in a quantum computer comprises storing the adjusted dynamical decoupling control sequence in a control electronics memory of the quantum computer.

The subject matter described in this specification can be implemented in particular ways so as to realize one or more of the following advantages.

During execution of a quantum algorithm, dynamical decoupling control sequences are used to preserve qubit states in waiting periods. For example, in quantum error correction, dynamical decoupling control sequences can be used to preserve quantum information stored by data qubits whilst corresponding measure qubit are measured. Sometimes, it is advantageous to also apply a target unitary operation, e.g., an arbitrary angle phase gate, to the qubits after the qubits have been dynamically decoupled, e.g., to perform phase matching.

The present disclosure describes techniques for implementing target unitary operations during dynamical decoupling. Single-qubit gates included in a dynamical decoupling control sequence are modified to change the overall action of the dynamical decoupling control sequence in order to output an overall target unitary operation, without increasing the circuit depth of the dynamical decoupling control sequence or requiring additional execution time. Further, since increased circuit depth generally also increases the likelihood of the occurrence of errors in a quantum computation, the presently described techniques can implement arbitrary unitary operations during dynamical decoupling with reduced errors, e.g., compared to techniques that separately perform operations for dynamical decoupling followed by operations for implementing the unitary operations.

In addition, the presently described techniques can be used to implement arbitrary coherent rotations during dynamical decoupling. In the context of phase matching, such rotations are typically Z rotations, however the techniques can be used to implement any coherent single-qubit gate. For example, we can also include a net rotation about an axis in the X/Y plane.

In addition, the presently described techniques can be applied in various settings to reduce quantum circuit depth, computation execution time, and the likelihood of errors. For example, the presently described techniques can be used to implement phase matching with looping instructions. The deliberate phase rotation implemented by the presently described techniques allows qubits to begin each loop iteration with a correctly aligned phase. This way, the same control waveforms can be replayed repeatedly, and the resultant operations have the correct phase. This enables indefinitely repeating sequences for quantum error correction.

In addition, the presently described techniques can be used to build logical operators (e.g., a logical Z or a logical S in a quantum error correcting code) into a measurement+reset/dynamical decoupling moment. For example, in some quantum error correcting codes and at some points in the operation of a fault-tolerant quantum computer, it can be useful to apply a logical Pauli-Z operator to a logical qubit. This can be performed through application of a string of physical Z operators to data qubits included in the logical qubit. This can be achieved using the presently described technique by having the data qubits along the string implement a Z rotation during measurement+reset, in order to save space and complexity of the implementation.

In addition, presently described techniques can also be used to correct coherent phase errors that occur during measurement+reset operations. Fixing coherent phase errors during a measurement+reset operation fixes issues in the quantum computing device. During measurement+reset operations, crosstalk can occur which can lead to physical rotations of data qubit states. These physical rotations should be mostly dealt with by the dynamical decoupling control sequence itself, but any residual effects can be fixed up by inverting the phase error directly.

Details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example system for implementing target unitary operations during dynamical decoupling.

FIG. 2 is an illustration of an example process for modifying an XY-4 dynamical decoupling scheme.

FIG. 3 is an illustration of an example process for modifying an 2n Tt-pulse dynamical decoupling scheme.

FIG. 4 is an illustration of an example process for modifying an (2n+1)π-pulse dynamical decoupling scheme.

FIG. 5 is an illustration of an example process for modifying an n π-pulse dynamical decoupling scheme.

FIG. 6 is a flow diagram of an example process for generating a control sequence that dynamically decouples and applies a target unitary operation to a qubit.

FIG. 7 depicts an example quantum computing device.

### DETAILED DESCRIPTION

Standard dynamical decoupling sequences act as an overall identity operation on the qubits they are applied to, with the goal of not impacting the logic of the qubits while still reducing the impact of noise. However, at times it is helpful to have an arbitrary unitary operation, e.g., an arbitrary angle phase gate, applied to the qubits, e.g., in order to aid with phase matching.

This specification describes techniques for implementing unitary operations, e.g., coherent rotations, during dynamical decoupling. Single qubit gates included in the dynamical decoupling control sequence are modified to change the overall action of the dynamical decoupling control sequence in order to output the unitary operation. For example, the phases of the single qubit gates included in the dynamical decoupling control sequence can be modulated to change the overall action of the dynamical decoupling sequence in order to output an overall phase gate. In the context of phase matching, the phase gate is generally a gate that rotates the state of a qubit around the Z axis, however the unitary operation can be any coherent single-qubit gate. For example, the unitary operation can be a single qubit gate that rotates a qubit state about an axis in the X/Y plane.

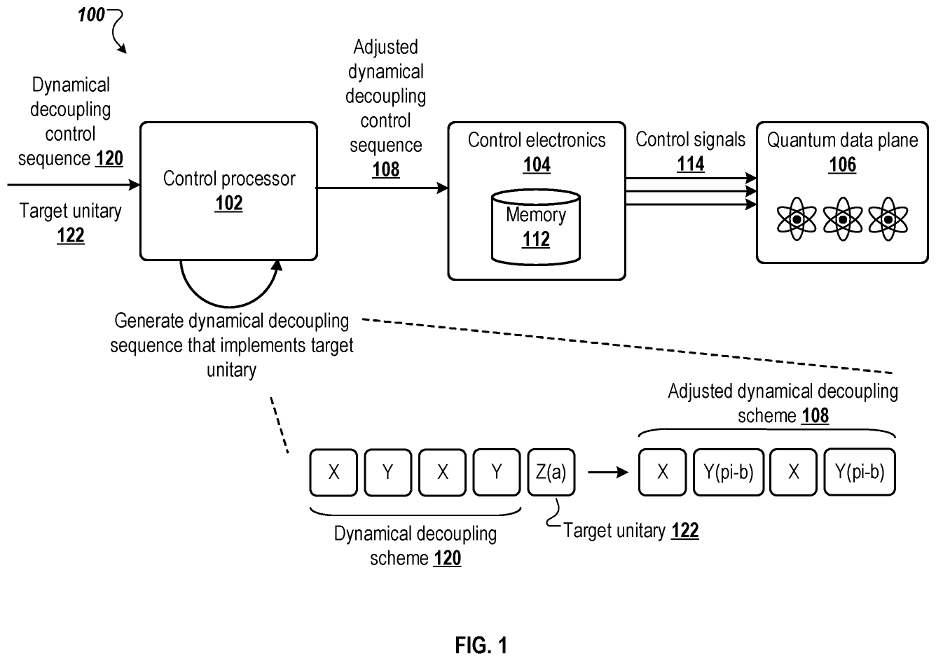

FIG. 1 depicts an example system 100 for implementing target unitary operations during dynamical decoupling. The example system 100 is an example of a system implemented as part of a quantum computing device in which the systems, components and techniques described in this specification can be implemented.

The system 100 includes a control processor 102, control electronics 104, and a quantum data plane 106. In some implementations, some or all of the components of the example system 100 can be directly connected. In other implementations, some or all of the components of the example system 100 can be connected through a network, e.g., a local area network (LAN), wide area network (WAN), the Internet, or a combination thereof.

The control processor 102 is a classical processor that can be implemented as one or more computer programs, i.e., one or more modules of computer program instructions encoded on a tangible non-transitory storage medium for execution by, or to control the operation of, a data processing apparatus. The computer storage medium can be a machine-readable storage device, a machine-readable storage substrate, a random or serial access memory device, one or more qubits, or a combination of one or more of them.

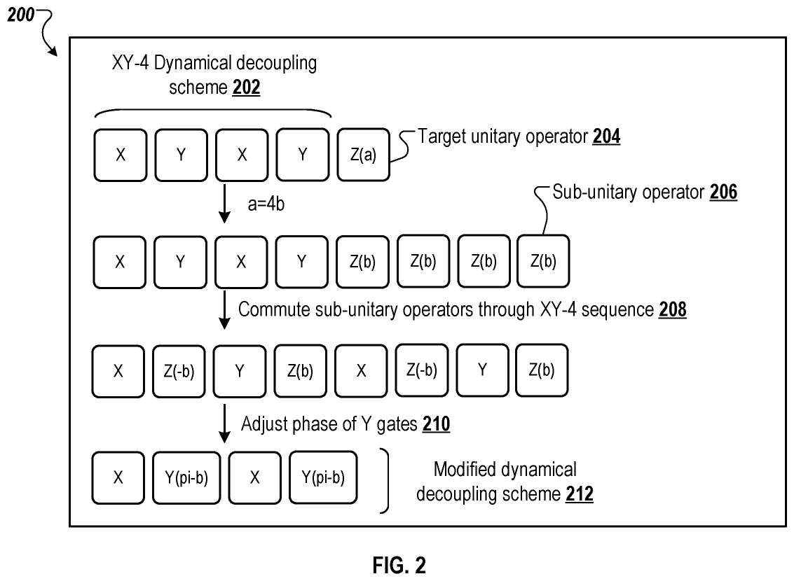

The control processor 102 is configured to receive as input data specifying a dynamical decoupling control sequence 120 and data specifying a target unitary operation 122. The dynamical decoupling control sequence 120 is a sequence of operations/quantum logic gates that, when applied to a qubit, dynamically decouples the qubit (e.g., suppresses decoherence) without impacting the logic of the qubit, i.e., acts as an identity operation. In some implementations the dynamical decoupling control sequence 120 can include Pauli-X gates and Pauli-Y gates. In the example shown in FIG. 1, the dynamical decoupling control sequence 120 is a XY-4 control sequence. Other example dynamical decoupling control sequences are described below with reference to FIGS. 2-5.

The target unitary operation 122 can be any coherent single qubit gate, e.g., a phase gate (such as a gate that implements a single qubit rotation about the Z axis) or more generally any arbitrary Pauli rotation. In the example shown in FIG. 1, the target unitary operation 122 is a phase gate Z(a) that rotates a qubit state around the Z axis by an angle α.

The control processor 102 is configured to modify single qubit gates included in the dynamical decoupling control sequence 120 and generate an adjusted dynamical decoupling control sequence 108 that, when applied to a qubit included in the quantum data plane 106, both dynamically decouples the qubit and implements the target unitary operation 122. To modify the single qubit gates included in the dynamical decoupling control sequence 120, the control processor 102 factors the target unitary operation 122 as a product of multiple sub-unitary operations and interleaves one or more of the sub-unitary operations through the dynamical decoupling control sequence 120 using commutation relations of the sub-unitary operations and the single qubit gates included in the dynamical decoupling control sequence 120. The control processor 102 then adjusts one or more single qubit gates included in the dynamical decoupling control sequence 120 to include the interleaved sub-unitary operations, e.g., modulates phases of the single qubit gates included in the dynamical decoupling control sequence 120 to absorb phases of the sub-unitary operations. In the example shown in FIG. 1, the control processor 102 re-phases the Pauli-Y gates included in the dynamical decoupling control sequence 120 to obtain the adjusted dynamical decoupling control sequence 108. Other example adjusted dynamical decoupling control sequences are described below with reference to FIGS. 2-5.

The control processor 102 is configured to provide data representing the adjusted dynamical decoupling control sequence 108 to the control electronics 104. The control electronics 104 is configured to convert data received from the control processor 102, e.g., digital signals representing control sequences such as the adjusted dynamical decoupling control sequence 108, to analog control signals 114 required to perform the operations on qubits included in the quantum data plane 106. For example, the control electronics 104 can include control devices that operate physical qubits included in the quantum data plane 106. Example control devices include arbitrary waveform generators or control devices that tune frequencies of respective qubits by applying control signals, e.g., voltage pulses, to the qubits through respective control lines. In some implementations the control electronics 104 can include a memory 112 that is configured to store data, e.g., data specifying pre-defined control sequences generated by the control processor 102 such as the adjusted dynamical decoupling control sequence 108.

The quantum data plane 106 includes physical qubits for performing quantum computations. The type of qubits that the quantum data plane 106 utilizes is dependent on the types of computations being performed by the system 100. For example, in some cases the quantum data plane 106 can include one or more resonators attached to one or more superconducting qubits, e.g., Gmon or Xmon qubits. In other cases, the quantum data plane 106 can include ion traps, photonic devices or superconducting cavities. Further examples of realizations of qubits include fluxmon qubits, silicon quantum dots or phosphorus impurity qubits. In some cases, the qubits may be a part of a quantum circuit.

Example operations performed by components of the system 100 are described in more detail below with reference to FIGS. 2-6.

FIG. 2 is an illustration 200 of an example process for modifying an XY-4 dynamical decoupling scheme 202 to generate a control sequence that, when applied to a qubit, dynamically decouples the qubit and applies a target unitary operation 204 to the qubit.

The XY-4 dynamical decoupling scheme 202 includes four quantum gates: a first Pauli-X gate (e.g., which can be implemented through application of a n pulse about the x axis), followed by a first Pauli-Y gate (e.g., which can be implemented through application of a n pulse about the y axis), followed by a second Pauli-X gate, followed by a second Pauli-Y gate. Although not shown in FIG. 2, in some implementations the four quantum gates can be implemented with an inter-gate delay (e.g., period of free evolution) of duration t. In the example shown in FIG. 2, the target unitary operation 204 is a phase gate Z(a) that rotates a qubit state around the Z axis by an angle a.

To modify the XY-4 dynamical decoupling scheme 202, the target unitary operation 204 is factored into a product of multiple sub-unitary operations, e.g., sub-unitary operation 206. In this example, the number of sub-unitary operations is equal to the number of quantum gates included in the XY-4 dynamical decoupling scheme 202. That is, Z(a)=Z(b)Z(b)Z(b)Z(b) where a=4b.

The sub-unitary operations are then commuted 208 through the XY-4 dynamical decoupling scheme so that each quantum gate included in the XY-4 dynamical decoupling scheme 202 is interleaved with a respective sub-unitary operator. In this example, the commutation relations Z(θ)X=XZ(−θ) and Z(θ)Y=YZ(−θ) for arbitrary angle θ are used to interleave the sub-unitary operations through the dynamical decoupling control sequence (therefore, sub-unitary operations Z(b) that cross an even number of X or Y gates have a positive angle b and sub-unitary operations Z(b) that cross an odd number of X or Y gates have a negative angle-b.

The Pauli-Y gates included in the XY-4 dynamical decoupling scheme 202 are then adjusted to include/absorb the neighboring sub-unitary operations. That is, the phase of each Pauli-Y gate is adjusted 210 to include the phases of its neighboring sub-unitary operations, e.g., the product of gates Z(−b)Y(π)Z(b) is combined to produce a gate Y(π−b) which is a Pauli-Y gate that rotates a qubit state by angle π and around an axis that is equal to the Y axis offset by angle b. In other words, when an X or Y operator is applied between Z rotations of opposite directions, the qubit state rotates about the Z axis, is flipped by the X or Y operator, and rotated back about the Z axis. Therefore, the qubit state is effectively flipped about a different axis.

The resulting modified XY-4 dynamical decoupling scheme 212 can then be stored, e.g., in control electronics memory, and/or a sequence of control pulses can be generated and applied to a qubit according to the modified XY-4 dynamical decoupling scheme 212 to dynamically decouple the qubit and implement the target unitary operation 204.

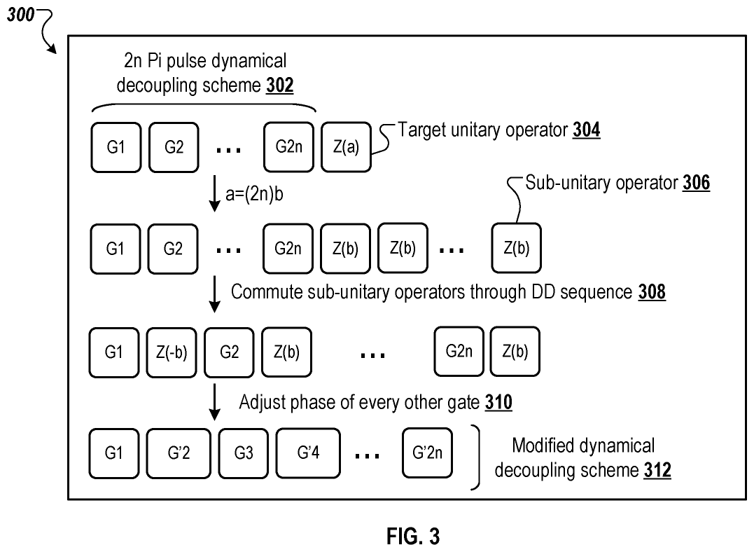

FIG. 3 is an illustration 300 of an example process for modifying an 2n π-pulse dynamical decoupling scheme 302 to generate a control sequence that, when applied to a qubit, dynamically decouples the qubit and applies a target unitary operation 304 to the qubit. The 2n π-pulse dynamical decoupling scheme 302 can be a XY-4, XY-8, etc., dynamical decoupling scheme.

The 2n π-pulse dynamical decoupling scheme 302 includes 2n quantum gates G₁, . . . , G₂ₙ, where each quantum gate Gᵢ in the dynamical decoupling scheme 302 can be implemented by a respective n pulse about the x, y, or z axis. For example, the quantum gates G₁, . . . , G₂ₙ can include Pauli-X and Pauli-Y gates. Although not shown in FIG. 3, in some implementations the 2n quantum gates can be implemented with an inter-gate delay (e.g., period of free evolution) of duration t. In the example shown in FIG. 3, the target unitary operation 304 is a phase gate Z(a) that rotates a qubit state around the Z axis by an angle α.

To modify the 2n Tt-pulse dynamical decoupling scheme 302, the target unitary operation 304 is factored into a product of multiple sub-unitary operations, e.g., sub-unitary operation 306. In this example, the number of sub-unitary operations is equal to the number of quantum gates included in the 2n T-pulse dynamical decoupling scheme 302. That is, Z(a)=Z(b)Z(b) . . . . Z(b) where a=(2n) b.

The sub-unitary operations are then commuted 308 through the 2n π-pulse dynamical decoupling scheme 302 so that each quantum gate included in the 2n π-pulse dynamical decoupling scheme 302 is interleaved with a respective sub-unitary operator. In this example, the commutation relations Z(θ) X=XZ(−θ) and Z(θ)Y=YZ(−θ) for arbitrary angle θ are used to interleave the sub-unitary operations through the dynamical decoupling control sequence (as described above with reference to FIG. 2).

Alternating gates included in the 2n π-pulse dynamical decoupling scheme 302 are then adjusted to include/absorb the neighboring sub-unitary operations. That is, the phase of every other gate, e.g., G₂, G₄, . . . . G₂ₙ is adjusted 310 to include the phases of its neighboring sub-unitary operations to generate adjusted quantum gates, e.g., G′₂, G′₄, . . . . G′₂ₙ where G′ represents a quantum gate G implemented by a π-pulse about a respective axis that has been shifted by angle b=a/2n. The resulting modified 2n π-pulse dynamical decoupling scheme 312 can then be stored, e.g., in control electronics memory, and/or a sequence of control pulses can be generated and applied to a qubit according to the modified 2n π-pulse dynamical decoupling scheme 312 to dynamically decouple the qubit and implement the target unitary operation 304.

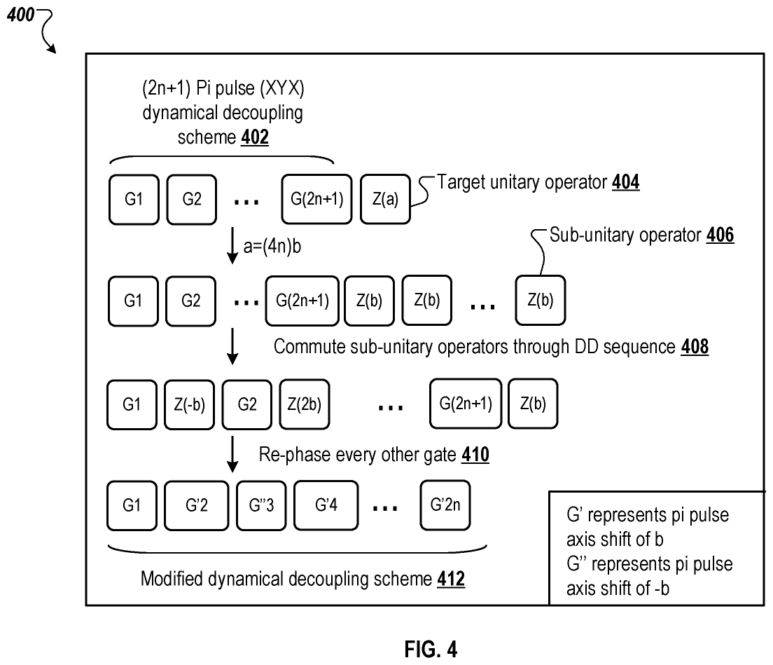

FIG. 4 is an illustration 400 of an example process for modifying an (2n+1) π-pulse dynamical decoupling scheme 402 to generate a control sequence that, when applied to a qubit, dynamically decouples the qubit and applies a target unitary operation 404 to the qubit. The (2n+1)π-pulse dynamical decoupling scheme 402 can be a XXX, XYXYX, etc., decoupling scheme.

The (2n+1) π-pulse dynamical decoupling scheme 402 includes 2n+1 quantum gates G₁, . . . , G₂ₙ₊₁, where each quantum gate Gᵢ in the (2n+1) π-pulse dynamical decoupling scheme 402 can be implemented by a respective π pulse about the x, y, or z axis. For example, the quantum gates G₁, . . . , G₂ₙ₊₁ can include Pauli-X and Pauli-Y gates. Although not shown in FIG. 4, in some implementations the 2n+1 quantum gates can be implemented with an inter-gate delay (e.g., period of free evolution) of duration t. In the example shown in FIG. 4, the target unitary operation 404 is a phase gate Z(a) that rotates a qubit state around the Z axis by an angle α.

To modify the (2n+1) π-pulse dynamical decoupling scheme 402, the target unitary operation 404 is factored into a product of multiple sub-unitary operations, e.g., sub-unitary operation 406. In this example, the number of sub-unitary operations is equal to the number of quantum gates included in the 2n+1 π-pulse dynamical decoupling scheme 402. Further, in this example, the sub-unitary operations include different sub-unitary operations (operations with different rotation angles)−2Z(b) operations and (2n−1)Z(2b) operations. That is, Z(a)=Z(b)Z(2b) . . . . Z(2b)Z(b) where in total there is a rotation of 2(b)+(2n−1)(2b)=2b+4nb−2b=4nb=a.

The sub-unitary operations are then commuted 408 through the 2n+1 π-pulse dynamical decoupling scheme 402 so that each quantum gate included in the 2n+1 π-pulse dynamical decoupling scheme 402 is interleaved with a respective sub-unitary operator (where again, the commutation relations Z(θ) X=XZ(−θ) and Z(θ)Y=YZ(−θ) for arbitrary angle θ are used to interleave the sub-unitary operations through the dynamical decoupling control sequence).

Each gate (other than the first gate) included in the 2n+1 π-pulse dynamical decoupling scheme 402 is then adjusted to absorb one or more neighboring sub-unitary operations. That is, the phase of each of the gates G₂, G₃, . . . . G₂ₙ₊₁ is adjusted 410 to include phases of one or more of its neighboring sub-unitary operations to generate adjusted quantum gates, e.g., G′₂, G″₃, . . . . G′₂n where G′ represents a quantum gate G implemented by a π-pulse about a respective axis that has been shifted by angle b and G″ represents a quantum gate G implemented by a π-pulse about a respective axis that has been shifted by angle-b. In this example, the first and last phase rotations have an angle +/−b, and the interior phase rotations have an angle +/−2b. The interior phases are split into two even pieces, one of which is absorbed into re-phasing the previous X or Y gate, and one which rephases the following X or Y gate. Since the re-phasing is dependent on the sign of the phases, which are opposite for the phases before and after the X or Y gate, a phase of b before a gate and one after rephase the microwave in opposite directions, hence the G′ and G″.

The resulting modified 2n+1 π-pulse dynamical decoupling scheme 412 can then be stored, e.g., in control electronics memory, and/or a sequence of control pulses can be generated and applied to a qubit according to the modified 2n+1-pulse dynamical decoupling scheme 412 to dynamically decouple the qubit and implement the target unitary operation 404.

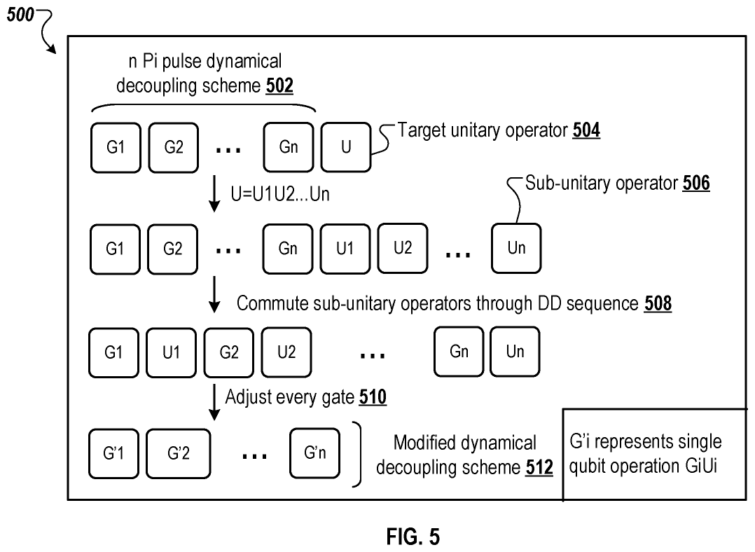

FIG. 5 is an illustration 500 of an example process for modifying an n π-pulse dynamical decoupling scheme 502 to generate a control sequence that, when applied to a qubit, dynamically decouples the qubit and applies a target unitary operation 504 to the qubit.

The n π-pulse dynamical decoupling scheme 502 includes n quantum gates G₁, . . . , Gₙ, where each quantum gate Gᵢ in the dynamical decoupling scheme 502 can be implemented by a respective π pulse about the x, y, or z axis. For example, the quantum gates G₁, . . . , Gₙ can include Pauli-X and Pauli-Y gates. Although not shown in FIG. 5, in some implementations the n quantum gates can be implemented with an inter-gate delay (e.g., period of free evolution) of duration t. In the example shown in FIG. 5, the target unitary operation 504 is an arbitrary unitary operator U, e.g., a quantum gate that implements an arbitrary Pauli rotation.

To modify the n π-pulse dynamical decoupling scheme 502, the target unitary operation 504 is factored into a product of multiple sub-unitary operations, e.g., sub-unitary operation 506. In this example, the number of sub-unitary operations is equal to the number of quantum gates included in the n π-pulse dynamical decoupling scheme 302. That is, U=U₁U₂ . . . . Uₙ where each sub-unitary operation Uᵢ can be commuted through gates Gᵢ₊₁, Gᵢ₊₂, . . . . Gₙ.

The sub-unitary operations are then commuted 508 through respective portions of the n Tt-pulse dynamical decoupling scheme 502 so that each quantum gate included in the n π-pulse dynamical decoupling scheme 502 is interleaved with a respective sub-unitary operator.

Each gate included in the n π-pulse dynamical decoupling scheme 502 is then adjusted to include one of its neighboring sub-unitary operations. That is, the phase or pulse amplitude of each gate is adjusted 510 to generate adjusted quantum gates, e.g., G′₁, G′₂, . . . . G′n where Gᵢ′ represents a single qubit operation with a unitary operator GᵢUᵢ.

The resulting modified n π-pulse dynamical decoupling scheme 512 can then be stored, e.g., in control electronics memory, and/or a sequence of control pulses can be generated and applied to a qubit according to the modified n π-pulse dynamical decoupling scheme 512 to dynamically decouple the qubit and implement the target unitary operation 504.

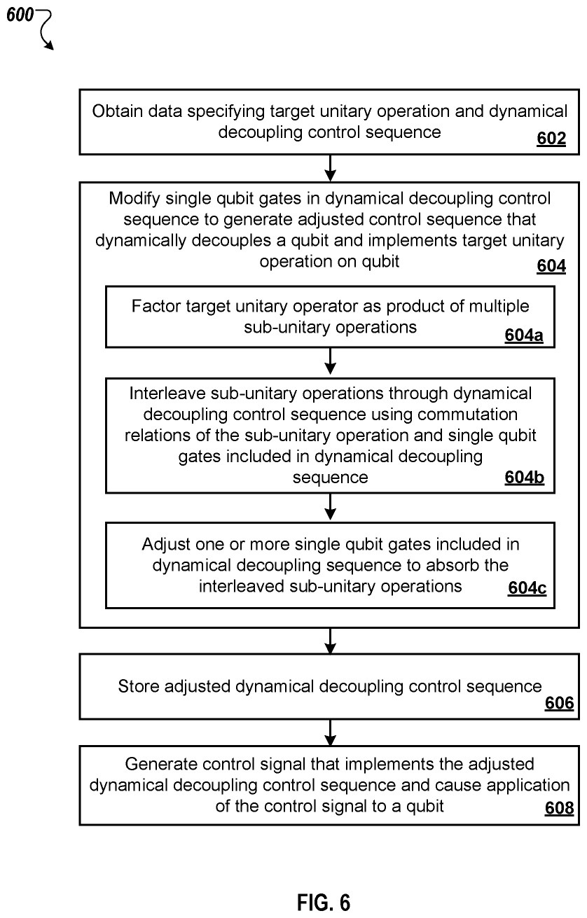

FIG. 6 is a flow diagram of an example process 600 for generating a control sequence that dynamically decouples and applies a target unitary operation to a qubit. For convenience, the process 600 will be described as being performed by classical and quantum components of a quantum computing system. For example, the system 100 of FIG. 1, appropriately programmed in accordance with this specification, can perform the process 600.

The system obtains data specifying a target unitary operation and data specifying a dynamical decoupling control sequence (step 602). The target unitary operation can be any coherent single qubit gate, e.g., a phase gate (such as a gate that implements a single qubit rotation about the Z axis) or more generally any arbitrary Pauli rotation. The dynamical decoupling control sequence is a sequence of operations/quantum logic gates that, when applied to a qubit, dynamically decouples the qubit without impacting the logic of the qubit, e.g., acts as an identity operation. That is, application of the decoupling control sequence to the qubit is equivalent to application of an identity operation to the qubit. In some implementations the dynamical decoupling control sequence can include Pauli-X gates and Pauli-Y gates. For example, the dynamical decoupling control sequence can be an n Pi pulse dynamical decoupling control sequence, a 2n Pi pulse dynamical decoupling control sequence, or a 2n+1 Pi pulse dynamical decoupling control sequence.

The system modifies single qubit gates included in the dynamical decoupling control sequence to generate an adjusted dynamical decoupling control sequence that, when applied to a qubit, dynamically decouples the qubit and implements the target unitary operation (step 604).

To modify the single qubit gates, the system factors the target unitary operation as a product of multiple sub-unitary operations (step 604a). In some implementations the dynamical decoupling control sequence includes a first number n of single qubit gates and the system can factor the target unitary operation into a product of n sub-unitary operations. For example, the target unitary operation can be a target phase gate that phases a qubit by an angle α, e.g., implements a single qubit rotation a. The system can then factor the target phase gate into a product of sub-unitary operations where each sub-unitary operation phases a qubit by an angle α/n, e.g., implements a single qubit rotation a/n.

In the examples given in the present disclosure, the target unitary operation is usually factored into a product of multiple sub-unitary operations that are evenly distributed through the dynamical decoupling control sequence, e.g., so that the target unitary operation is factored into a number of gates that is equal to the number of gates in the dynamical decoupling control sequence. However, in some implementations the target unitary operation can be factored into a number of gates that is less than the number of gates in the dynamical decoupling control sequence. Alternatively, or in addition, the sub-unitary operations can be unevenly distributed through the dynamical decoupling control sequence. Numerical simulations have shown that uneven distributions can be equally robust as even distributions, e.g., for simple error models such as depolarizing channel error models. However, in some implementations (e.g., for more complex error models) even distributions can provide improved robustness because they are in some ways the closest to the standard robust pulses.

The system then interleaves one or more of the sub-unitary operations through the dynamical decoupling control sequence using commutation relations of the sub-unitary operations and the single qubit gates included in the dynamical decoupling control sequence (step 604b). In some implementations the system can interleave the sub-unitary operations by evenly distributing the one or more sub-unitary operations throughout the dynamical decoupling control sequence, e.g., as shown in the examples described above with reference to FIGS. 2-5.

The system then adjusts one or more single qubit gates included in the dynamical decoupling control sequence to include the interleaved sub-unitary operations (step 604c). For example, in implementations where the target unitary operation is a target phase operation, the system can adjust a single qubit gate included in the dynamical decoupling control sequence to include one or more neighboring interleaved sub-unitary operations by re-phasing the single qubit gate such that the phases of the one or more neighboring interleaved sub-unitary operations are absorbed (i.e., combined) with a phase of the single qubit gate. Example re-phasing of single qubit gates included in a dynamical decoupling control sequence are described above with reference to FIGS. 2-5.

In some implementations the system adjusts a proper subset of the single qubit gates included in the dynamical decoupling control sequence to include the interleaved sub-unitary operations, i.e., does not adjust every single qubit gate included in the dynamical decoupling control sequence. In some implementations the proper subset of single qubit gates can include single qubit gates of a same type, e.g., as shown in the example described above with reference to FIG. 2.

In some implementations the system can store the adjusted dynamical decoupling control sequence, e.g., in control electronics memory (step 606). For example, the system can perform steps 602-606 described above in advance so that when the system subsequently performs a quantum computation, the adjusted dynamical decoupling control sequence need not be generated on-the-fly but retrieved from memory and applied to one or more qubits (step 608). Alternatively, the system can perform steps 602 and 604 described above and then cause application of the adjusted dynamical decoupling control sequence to a qubit (step 608) (i.e., without storing the adjusted dynamical decoupling control sequence).

For example, in some implementations the quantum computing device can be executing a quantum computation. During execution of the quantum computation, the system can determine that a qubit requires dynamical decoupling and application of the target unitary operation. In response to determining that the qubit requires dynamical decoupling and application of the target unitary operation, the system can either generate the required adjusted dynamical decoupling control sequence in real time or retrieve a pre-stored adjusted dynamical decoupling control sequence, generate a control signal that implements the adjusted dynamical decoupling control sequence, and apply the control signal to the qubit.

The techniques described in this specification can be implemented in a variety of settings. For example, in some implementations, example process 600 can be used to generate and apply an adjusted dynamical decoupling control sequence during execution of a quantum computation that requires phase matching, i.e., a quantum computation that requires dynamically decoupled qubits to also have a target phase.

For example, in repeated loop quantum computations, it may be required that one or more qubits involved in the quantum computation are dynamically decoupled before each loop begins and that the one or more qubits begin each loop with a correctly aligned phase. Therefore, in these examples, the system can perform step 608 of example process at the beginning of each loop.

An example repeated loop quantum computation is a quantum error corrected quantum computation, where a quantum error correction quantum circuit is repeatedly applied to a system of data qubits and measure qubits. In this context, dynamical decoupling can be used to preserve quantum information stored by the data qubits whilst the corresponding measure qubit are measured. By applying the presently described adjusted dynamical decoupling control sequence, e.g., performing step 608 of example process 600 at the beginning of each cycle of quantum error correction, the waiting data qubits can be both dynamically decoupled to reduce the impact of noise and correctly phased for the next error correction cycle-without requiring application of separate control sequences and therefore reducing circuit depth and execution time.

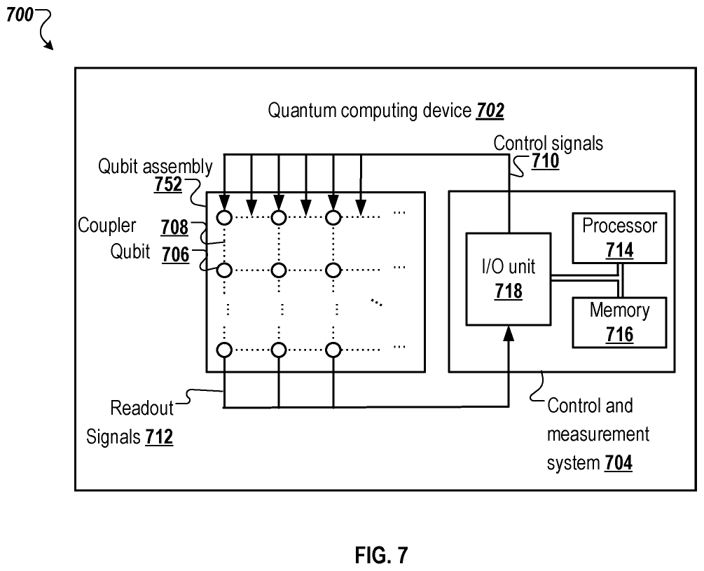

FIG. 7 depicts an example quantum computer 700 for performing the quantum operations described in this specification. The example quantum computer 700 includes an example quantum computing device 702. The quantum computing device 702 is intended to represent various forms of quantum computing devices. The components shown here, their connections and relationships, and their functions, are exemplary only, and do not limit implementations of the inventions described and/or claimed in this document.

The example quantum computing device 702 includes a qubit assembly 752 and a control and measurement system 704. The qubit assembly includes multiple qubits, e.g., qubit 706, that are used to perform algorithmic operations or quantum computations. While the qubits shown in FIG. 7 are arranged in a rectangular array, this is a schematic depiction and is not intended to be limiting. The qubit assembly 752 also includes adjustable coupling elements, e.g., coupler 708, that allow for interactions between coupled qubits. In the schematic depiction of FIG. 7, each qubit is adjustably coupled to each of its four adjacent qubits by means of respective coupling elements. However, this is one example arrangement of qubits and couplers. Other arrangements are possible, including arrangements that are non-rectangular, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 702 included in the example computer 700 or the type of quantum computations that the quantum computing device is performing. For example, in an atomic quantum computer the qubits may be realized via atomic, molecular or solid-state quantum systems, e.g., hyperfine atomic states. As another example, in a superconducting quantum computer the qubits may be realized via superconducting qubits or semi-conducting qubits, e.g., superconducting transmon states. As another example, in a NMR quantum computer the qubits may be realized via nuclear spin states.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits, e.g., to implement the surface code circuits described in this specification. Example quantum logic gates include single-qubit gates, e.g., Pauli-X, Pauli-Y, Pauli-Z(also referred to as X, Y, Z), Hadamard gates, S gates, rotations, two-qubit gates, e.g., controlled-X, controlled-Y, controlled-Z(also referred to as CX, CY, CZ), controlled NOT gates (also referred to as CNOT) controlled swap gates (also referred to as CSWAP), iSWAP gates, and gates involving three or more qubits, e.g., Toffoli gates. The quantum logic gates can be implemented by applying control signals 710 generated by the control and measurement system 704 to the qubits and to the couplers.

For example, in some implementations the qubits in the qubit assembly 752 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 710 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 710. The measurements cause readout signals 712 representing measurement results to be communicated back to the measurement and control system 704. The readout signals 712 may include RF, microwave, or optical signals depending on the physical scheme for the quantum computing device and/or the qubits. For convenience, the control signals 710 and readout signals 712 shown in FIG. 7 are depicted as addressing only selected elements of the qubit assembly (i.e., the top and bottom rows), but during operation the control signals 710 and readout signals 712 can address each element in the qubit assembly 752.

The control and measurement system 704 is an example of a classical computer system that can be used to perform various operations on the qubit assembly 752, as described above, as well as other classical subroutines or computations. The control and measurement system 704 includes one or more classical processors, e.g., classical processor 714, one or more memories, e.g., memory 716, and one or more I/O units, e.g., I/O unit 718, connected by one or more data buses. The control and measurement system 704 can be programmed to send sequences of control signals 710 to the qubit assembly, e.g., to carry out a selected series of quantum gate operations, and to receive sequences of readout signals 712 from the qubit assembly, e.g., as part of performing measurement operations.

The processor 714 is configured to process instructions for execution within the control and measurement system 704. In some implementations, the processor 714 is a single-threaded processor. In other implementations, the processor 714 is a multi-threaded processor. The processor 714 is capable of processing instructions stored in the memory 716.

The memory 716 stores information within the control and measurement system 704. In some implementations, the memory 716 includes a computer-readable medium, a volatile memory unit, and/or a non-volatile memory unit. In some cases, the memory 716 can include storage devices capable of providing mass storage for the system, e.g., a hard disk device, an optical disk device, a storage device that is shared over a network by multiple computing devices (e.g., a cloud storage device), and/or some other large capacity storage device.

The input/output device 718 provides input/output operations for the control and measurement system 704. The input/output device 718 can include D/A converters, A/D converters, and RF/microwave/optical signal generators, transmitters, and receivers, whereby to send control signals 710 to and receive readout signals 712 from the qubit assembly, as appropriate for the physical scheme for the quantum computer. In some implementations, the input/output device 718 can also include one or more network interface devices, e.g., an Ethernet card, a serial communication device, e.g., an RS-232 port, and/or a wireless interface device, e.g., an 802.11 card. In some implementations, the input/output device 718 can include driver devices configured to receive input data and send output data to other external devices, e.g., keyboard, printer and display devices.

Although an example control and measurement system 704 has been depicted in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively, or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g. photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for generating a control sequence for implementing a unitary operation and dynamically decoupling a qubit, the method comprising:
obtaining data specifying a target unitary operation and data specifying a dynamical decoupling control sequence;
modifying single qubit gates included in the dynamical decoupling control sequence to generate an adjusted dynamical decoupling control sequence that, when applied to a qubit, dynamically decouples the qubit and implements the target unitary operation, wherein modifying the single qubit gates comprises:
factoring the target unitary operation as a product of multiple sub-unitary operations;
interleaving, using commutation relations of the sub-unitary operations and the single qubit gates included in the dynamical decoupling control sequence, one or more of the sub-unitary operations through the dynamical decoupling control sequence; and
adjusting one or more single qubit gates included in the dynamical decoupling control sequence to include the interleaved sub-unitary operations; and
providing the adjusted dynamical decoupling control sequence for application to one or more qubits in a quantum computer.

2. The method of claim 1, wherein interleaving one or more of the sub-unitary operations through the dynamical decoupling control sequence comprises evenly distributing the one or more sub-unitary operations throughout the dynamical decoupling control sequence.

3. The method of claim 1, wherein the dynamical decoupling control sequence comprises a first number n of single qubit gates and the multiple sub-unitary operations comprises n unitary operations.

4. The method of claim 3, wherein the target unitary operation comprises a target phase gate that implements a single qubit rotation a and each sub-unitary operation of the multiple sub-unitary operations implements a single qubit rotation a/n.

5. The method of claim 4, wherein adjusting one or more single qubit gates included in the dynamical decoupling control sequence to include the interleaved sub-unitary operations comprises adjusting phases of the one or more single qubit gates to include respective phases of the interleaved sub-unitary operations.

6. The method of claim 4, wherein the single qubit rotation comprises a single qubit rotation about the Z axis.

7. The method of claim 1, wherein adjusting one or more single qubit gates included in the dynamical decoupling control sequence to include the interleaved sub-unitary operations comprises adjusting a proper subset of the single qubit gates included in the dynamical decoupling control sequence to include the interleaved sub-unitary operations.

8. The method of claim 7, wherein the proper subset comprises single qubit gates of a same type.

9. The method of claim 1, wherein the target unitary operation comprises a coherent single qubit gate.

10. The method of claim 1, wherein application of the dynamical decoupling control sequence to a qubit is equivalent to an application of an identity operation to the qubit.

11. The method of claim 1, wherein the dynamical decoupling control sequence comprises X gates and Y gates.

12. The method of claim 1, wherein the dynamical decoupling control sequence comprises an n Pi pulse dynamical decoupling scheme, a 2n Pi pulse dynamical decoupling scheme, or a 2n+1 Pi pulse dynamical decoupling scheme.

13. The method of claim 1, wherein providing the adjusted dynamical decoupling control sequence for application to one or more qubits in a quantum computer comprises, during execution of a quantum computation by the quantum computer:
determining that one or more qubits require dynamical decoupling and application of the target unitary operation; and
in response to determining that the one or more qubits require dynamical decoupling and application of the target unitary operation, generating a control signal to apply the adjusted dynamical decoupling control sequence to the one or more qubits.

14. The method of claim 13, further comprising applying the generated control signal to the one or more qubits.

15. The method of claim 1, wherein providing the adjusted dynamical decoupling control sequence for application to one or more qubits in a quantum computer comprises storing the adjusted dynamical decoupling control sequence in a control electronics memory of the quantum computer.

16. A system comprising:
one or more processors;
one or more I/O devices coupled to the one or more processors and configured to send control signals to and receive readout signals from a quantum computer; and
one or more memories having stored thereon computer readable instructions configured to cause the one more processors and the one or more I/O devices to perform operations for generating a control sequence for implementing a unitary operation and dynamically decoupling a qubit, the operations comprising:
obtaining data specifying a target unitary operation and data specifying a dynamical decoupling control sequence;
modifying single qubit gates included in the dynamical decoupling control sequence to generate an adjusted dynamical decoupling control sequence that, when applied to a qubit, dynamically decouples the qubit and implements the target unitary operation, wherein modifying the single qubit gates comprises:
factoring the target unitary operation as a product of multiple sub-unitary operations;
interleaving, using commutation relations of the sub-unitary operations and the single qubit gates included in the dynamical decoupling control sequence, one or more of the sub-unitary operations through the dynamical decoupling control sequence; and
adjusting one or more single qubit gates included in the dynamical decoupling control sequence to include the interleaved sub-unitary operations; and
providing the adjusted dynamical decoupling control sequence for application to one or more qubits in a quantum computer.

17. A method for dynamically decoupling and performing a target unitary operation to a qubit, the method comprising:
generating a control signal that implements a dynamical decoupling control sequence; and
applying the control signal to the qubit to dynamically decouple the qubit and perform the target unitary operation on the qubit, wherein:
the target unitary operation comprises a product of multiple sub-unitary operations; and
the dynamical decoupling control sequence comprises a plurality of single qubit gates, wherein one or more of the single qubit gates comprise a single qubit gate that implements one or more of sub-unitary operations of the multiple sub-unitary operations.

18. The method of claim 17, wherein:
the target unitary operation comprises a target rotation operation; and
each single qubit gate that implements one or more of sub-unitary operations of the multiple sub-unitary operations comprises a single qubit gate with an initial phase or initial pulse amplitude that is modified using a phase or pulse amplitude of the one or more of sub-unitary operations.

19. The method of claim 17, wherein the initial phase or initial pulse amplitude comprise a phase or pulse amplitude specified by an initial dynamical decoupling control sequence, optionally wherein the initial dynamical decoupling control sequence comprises an n Pi pulse dynamical decoupling scheme, a 2n Pi pulse dynamical decoupling scheme, or a 2n+1 Pi pulse dynamical decoupling scheme.

20. A system comprising:
one or more processors;
one or more I/O devices coupled to the one or more processors and configured to send control signals to and receive readout signals from a quantum computer; and
one or more memories having stored thereon computer readable instructions configured to cause the one more processors and the one or more I/O devices to perform operations for dynamically decoupling and performing a target unitary operation to a qubit, the operations comprising:
generating a control signal that implements a dynamical decoupling control sequence; and
applying the control signal to the qubit to dynamically decouple the qubit and perform the target unitary operation on the qubit, wherein:
the target unitary operation comprises a product of multiple sub-unitary operations; and
the dynamical decoupling control sequence comprises a plurality of single qubit gates, wherein one or more of the single qubit gates comprise a single qubit gate that implements one or more of sub-unitary operations of the multiple sub-unitary operations.
